(19) United States
(12) Patent Application Publication
(10) Pub. No.: US 2009/0104837 A1
(43) Pub. Date: Apr. 23, 2009

(54) Cushioning device

(76) Inventors: Greg Manwaring, Otter Lake, MI (US); Teri Manwaring, Otter Lake, MI (US); Maranda Rhea, Otter Lake, MI (US)

Correspondence Address: JAMES RAY & ASSOCIATES, 2640 PITCAIRN ROAD, MONROEVILLE, PA, 15146, US

(21) Appl. No.: 12/287,096

(22) Filed: Oct. 6, 2008

Related U.S. Application Data
(60) Provisional application No. 60/999,796, filed on Oct. 19, 2007.

(51) Int. Cl. A63H 3/36; A61H 3/02

(52) U.S. Cl. 446/71; 135/66; 135/73

(57) ABSTRACT

A cushioning device for placement on a mobility aid at a predetermined location thereon is provided. Such cushioning device includes a cushion member having a first predetermined size and a first predetermined shape. A first securing mechanism is operably disposed on such cushion member for releasably securing such cushion member to such mobility aid.

### CROSS REFERENCE TO RELATED APPLICATION

This patent application is related to and claims priority from U.S. Provisional Patent Application Ser. No. 60/999,796 filed Oct. 19, 2007.

### FIELD OF THE INVENTION

The present invention relates, in general, to mobility aids such as crutches, walkers, wheelchairs, and the like and, more particularly, this invention relates to a cushioning and padding device for use with mobility aids and which may also serve to decorate such mobility aids and to make using such mobility support devices enjoyable.

### BACKGROUND OF THE INVENTION

Prior to the conception and development of the present invention, mobility aids such as crutches, wheelchairs, and walkers, as are generally well known in the prior art, have been used to aid ambulatory challenged individuals, individuals with weakened or injured limbs, persons with balance problems, elderly persons, and the like. However, these devices can be uncomfortable to use and may also be depressing to those who require them, and even scary to little children who must use them or are confronted by individuals using them. Therefore there is a need for a comfortable and decorative cushioning device which can be used with crutches, a wheel chair, a walker, and other mobility aids. It would be particularly useful to provide such cushioning device in the form of a predetermined animal, a predetermined person, a predetermined character, a doll, or the like, such that such cushioning device is enjoyable to use, play with, see, touch, and so on, and which will alleviate feelings of fear, depression, and anxiety which are often associated with the use of crutches, wheel chairs, walkers and other mobility aids by those individuals using such crutches, wheel chairs, walkers and the like and those around those individuals using such crutches, wheel chairs, walkers and the like.

### SUMMARY OF THE INVENTION

The present invention provides a cushioning device for placement on a mobility aid at a predetermined location thereon. Such cushioning device includes a cushion member having a first predetermined size and a first predetermined shape. A first securing means is operably disposed on such cushion member for releasably securing such cushion member to such mobility aid.

### OBJECTS OF THE INVENTION

It is, therefore, one of the primary objects of the present invention to provide a comfortable and decorative cushioning device which can be used with a mobility aid such as crutches, a wheel chair, a walker, and the like.

Another object of the present invention is to provide a comfortable and decorative cushioning device which can be secured to at least an underarm receiving portion of a crutch.

Still another object of the present invention is to provide a comfortable and decorative cushioning device for use with crutches, a wheel chair, a walker, and other ambulatory aids, such cushioning device being in the form of a predetermined animal, a predetermined person, a predetermined character, a doll, or the like, such that such cushioning device is enjoyable to use, play with, look at, touch, and the like.

Yet another object of the present invention is to provide a cushioning device for attachment to a mobility aid and which is also decorative, fun and uplifting, and alleviates and reduces feelings of fear, depression, and anxiety felt by those individuals using such mobility aid and those around such individuals using such mobility aid.

An additional object of the present invention is to provide an animal shaped crutch cushion for placement between an underarm of a user and an underarm supporting portion of such crutch for providing physical and mental comfort to such user.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a partial perspective view of the invention according to one embodiment of the invention in which the cushion member is shaped like a frog.

FIG. 2 is a partial perspective view of the invention according to one embodiment of the invention in which the underside of the invention is depicted.

FIG. 3 is a partial perspective view of the invention according to one embodiment of the invention in which the cushion member is shaped like a dog and in which the invention includes a second securing means.

FIG. 4 is a partial perspective view of the invention according to one embodiment of the invention in which the underside of the invention is depicted.

FIG. 5 is a partial perspective view of the invention according to one embodiment of the invention in which the invention has been attached to a crutch.

FIG. 6 is a partial perspective view of the invention according to one embodiment of the invention.

FIG. 7 is a partial perspective view of the invention according to one embodiment of the invention in which the invention has been attached to a walker.

FIG. 8 is a partial perspective view of the invention according to one embodiment of the invention in which the invention has been attached to a wheelchair.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

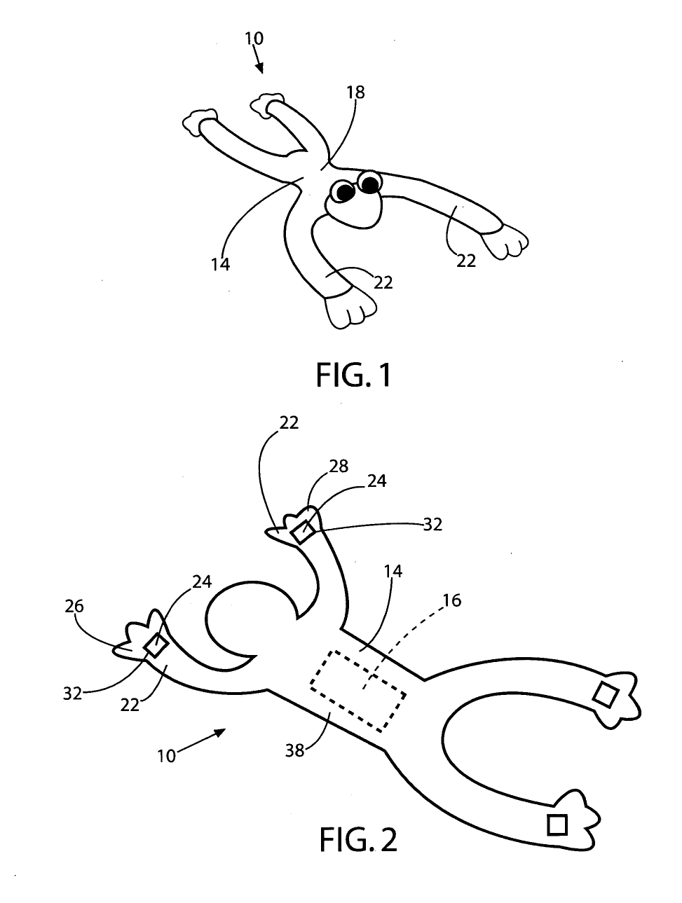

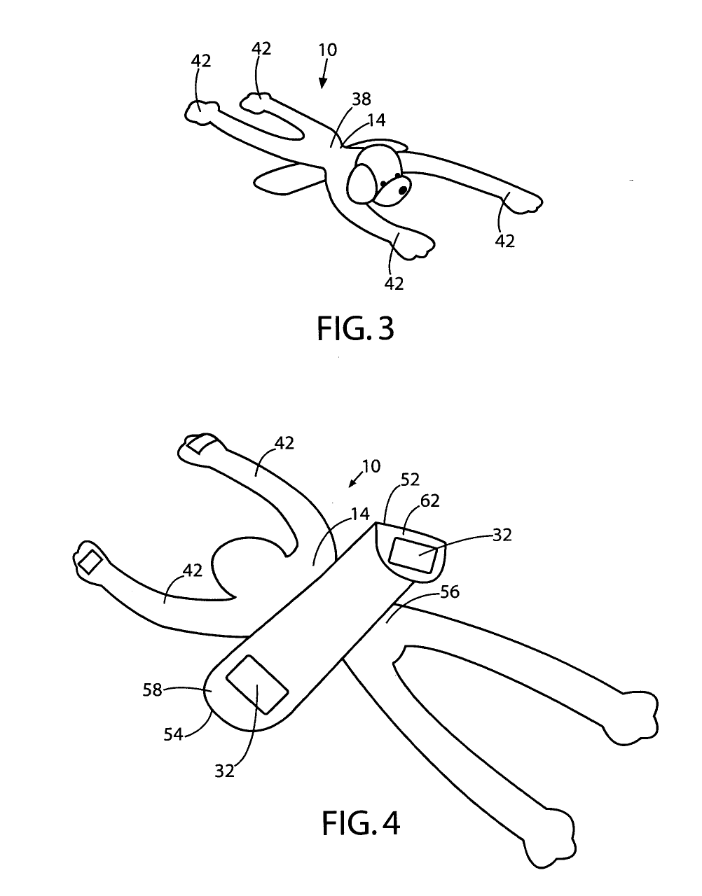

Reference is now made, more particularly, to FIGS. 1-8.

A cushioning device, generally designated 10, for placement on a mobility aid 12 at a predetermined location thereon, is provided. Such cushioning device 10 includes a cushion member 14 having a first predetermined size and a first predetermined shape. It is presently preferred that such cushion member 14 includes padding 16 disposed at least one of on and within such cushion member 14.

It is presently preferred that such first predetermined shape is at least one of a predetermined animal, a predetermined person, a predetermined character, a predetermined object, and a combination thereof.

It is presently most preferred that such first predetermined shape is a predetermined animal 18. It is presently preferred that such predetermined animal 18 has at least two appendages 22. However, the device 10 is not meant to be limited as such and such cushion member 14 may be any shape which reasonably facilitates its purpose including shapes such as animals and characters which do not have two appendages, for example, fish, snakes, worms, and the like.

A first securing means 24 is operably disposed on such cushion member 14 for securing such cushion member 14 to such mobility aid 12.

It is presently preferred that such first securing means 24 is disposed on such at least two appendages 22 at predetermined locations thereon such that a first one 26 of such at least two appendages 22 may be joined with at least a second one 28 of such at least two appendages 22.

It is presently preferred that such first securing means 24 is at least one of an adhesive type securing means, a hook and loop type securing means, a snap type securing means, a string type securing means, and a combination thereof. It is presently most preferred that such first securing means 24 is a hook and loop type securing means 32.

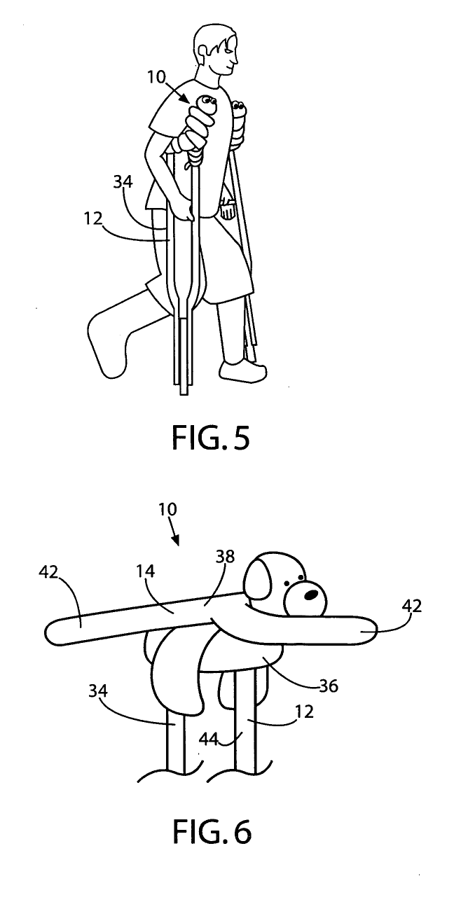

It is presently preferred that such mobility aid 12 is a crutch 34, as illustrated in FIG. 5 and FIG. 6, and such predetermined location is an underarm supporting portion 36 of such crutch 34 and wherein such at least one of such predetermined animal, such predetermined person, such predetermined character, such predetermined object, and such combination thereof includes a body portion 38 for placement at least one of on and over such underarm supporting portion 36 of such crutch 34 and wherein such first securing means 24 includes a predetermined plurality of appendages 42 disposed on such body portion 38 at predetermined locations thereon for releasably securing such cushioning device 10 to such crutch 34.

It is presently preferred that such predetermined plurality of appendages 42 are releasably securable to at least one of each other, at least one support member 44 extending perpendicularly downward from such underarm supporting portion 36 of such crutch 34, and a combination thereof.

It is presently preferred that such body portion 38 includes padding 16 disposed therein.

It is presently preferred that such device 10 further includes a second securing means 52 and such second securing means 52 is a strap type member 54 operably disposed on an underside 56 of such cushion member 14, such strap type member 54 having a first end 58 and a second end 62 and such first end 58 being releasably securable to such second end 62. Such first end 58 may be securable to such second end 62 by any securing means which facilitates such purpose. For example, in FIG. 4, a hook and loop type securing means 32 is depicted on such strap type member 54.

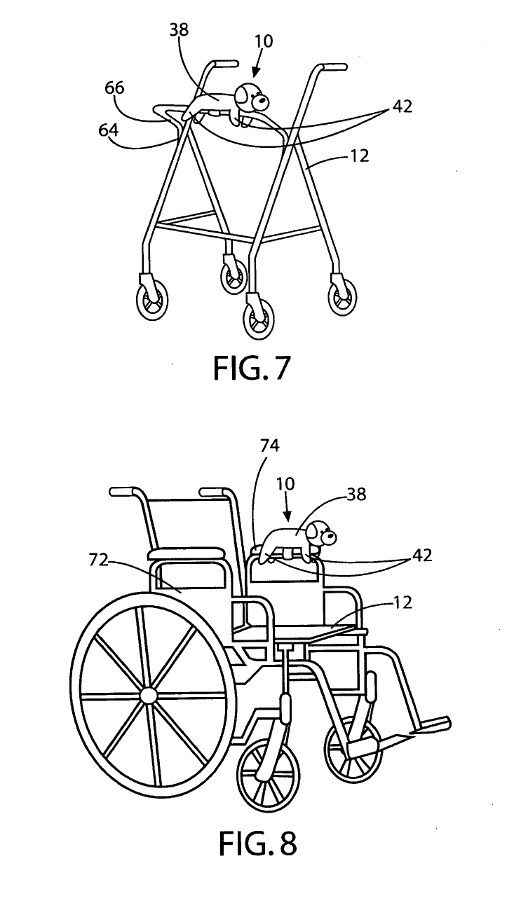

According to another embodiment, such mobility aid 12 is a walker 64, as illustrated in FIG. 7, and such predetermined location is a support bar 66 of such walker 64 and wherein such at least one of such predetermined animal, such predetermined person, such predetermined character, such predetermined object, and such combination thereof includes a body portion 38 for placement on such support bar 66 of such walker 64 and wherein such first securing means 24 includes a predetermined plurality of appendages 42 disposed on such body portion 38 for releasably securing such cushioning device 10 to such walker 64.

It is presently preferred that such predetermined plurality of appendages 42 are releasably securable to at least one of each other, such walker 64, and a combination thereof.

According to yet another embodiment, such mobility aid 12 is a wheelchair 72, as illustrated in FIG. 8, and such predetermined location is an armrest 74 of such wheelchair 72 and wherein such at least one of such predetermined animal, such predetermined person, such predetermined character, such predetermined object, and such combination thereof includes a body portion 38 for placement on such armrest 74 and wherein such first securing means 24 includes a predetermined plurality of appendages 42 disposed on such body portion 38 for releasably securing such cushioning device 10 to such wheelchair 72.

It is presently preferred that such predetermined plurality of appendages 42 are releasably securable to at least one of each other, such wheelchair 72, and a combination thereof.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. A cushioning device for placement on a mobility aid at a predetermined location thereon, said cushioning device comprising:
a. a cushion member having a first predetermined size and a first predetermined shape; and
b. a first securing means operably disposed on said cushion member for releasably securing said cushion member to such mobility aid.

2. A cushioning device for placement on a mobility aid at a predetermined location thereon according to claim 1 wherein said cushion member includes padding disposed at least one of on and within said cushion member.

3. A cushioning device for placement on a mobility aid at a predetermined location thereon according to claim 1 wherein said first securing means is at least one of an adhesive type securing means, a hook and loop type securing means, a snap type securing means, a string type securing means, and a combination thereof.

4. A cushioning device for placement on a mobility aid at a predetermined location thereon according to claim 3 wherein said first securing means is a hook and loop type securing means.

5. A cushioning device for placement on a mobility aid at a predetermined location thereon according to claim 1 wherein said device further includes a second securing means and said second securing means includes a strap type member operably disposed on an underside of said cushion member, said strap type member having a first end and a second end and said first end being releasably securable to said second end.

6. A cushioning device for placement on a mobility aid at a predetermined location thereon according to claim 1 wherein said first predetermined shape is at least one of a predetermined animal, a predetermined person, a predetermined character, a predetermined object, and a combination thereof.

7. A cushioning device for placement on a mobility aid at a predetermined location thereon according to claim 6 wherein said first predetermined shape is a predetermined animal.

8. A cushioning device for placement on a mobility aid at a predetermined location thereon according to claim 7 wherein said predetermined animal has at least two appendages.

9. A cushioning device for placement on a mobility aid at a predetermined location thereon according to claim 8 wherein said first securing means is disposed on said at least two appendages at predetermined locations thereon such that a first one of said at least two appendages may be joined with at least a second one of said at least two appendages.

10. A cushioning device for placement on a mobility aid at a predetermined location thereon according to claim 6 wherein such mobility aid is a crutch and such predetermined location is an underarm supporting portion of such crutch and wherein said at least one of said predetermined animal, said predetermined person, said predetermined character, said predetermined object, and said combination thereof includes a body portion for placement at least one of on and over such underarm supporting portion of such crutch and wherein said first securing means includes a predetermined plurality of appendages disposed on said body portion at predetermined locations thereon for releasably securing said cushioning device to said crutch.

11. A cushioning device for placement on a mobility aid at a predetermined location thereon according to claim 10 wherein said predetermined plurality of appendages are releasably securable to at least one of each other, at least one support member extending perpendicularly downward from such underarm supporting portion of such crutch, and a combination thereof.

12. A cushioning device for placement on a mobility aid at a predetermined location thereon according to claim 10 wherein said body portion includes padding disposed therein.

13. A cushioning device for placement on a mobility aid at a predetermined location thereon according to claim 6 wherein such mobility aid is a walker and such predetermined location is a support bar of such walker and wherein said at least one of said predetermined animal, said predetermined person, said predetermined character, said predetermined object, and said combination thereof includes a body portion for placement on such support bar of such walker and wherein said first securing means includes a predetermined plurality of appendages disposed on said body portion for releasably securing said cushioning device to such walker.

14. A cushioning device for placement on a mobility aid at a predetermined location thereon according to claim 13 wherein said predetermined plurality of appendages are releasably securable to at least one of each other, such walker, and a combination thereof.

15. A cushioning device for placement on a mobility aid at a predetermined location thereon according to claim 6 wherein such mobility aid is a wheelchair and such predetermined location is an armrest of such wheelchair and wherein said at least one of said predetermined animal, said predetermined person, said predetermined character, said predetermined object, and said combination thereof includes a body portion for placement on such armrest and wherein said first securing means includes a predetermined plurality of appendages disposed on said body portion for releasably securing said cushioning device to such wheelchair.

16. A cushioning device for placement on a mobility aid at a predetermined location thereon according to claim 15 wherein said predetermined plurality of appendages are releasably securable to at least one of each other, such wheelchair, and a combination thereof.
